(19) United States
(12) Patent Application Publication
(10) Pub. No.: US 2011/0093545 A1
(43) Pub. Date: Apr. 21, 2011

(54) VOICE-ACTIVATED ACQUISITION OF NON-LOCAL CONTENT

(75) Inventors: Manuela Papadopol, Seattle, WA (US); Gregory P. Baribault, Sammamish, WA (US)

(73) Assignee: MICROSOFT CORPORATION, Redmond, WA (US)

(21) Appl. No.: 12/603,491

(22) Filed: Oct. 21, 2009

(51) Int. Cl. G06F 15/16; G06F 3/16; G06F 3/00; G06Q 30/00; G06Q 50/00

(52) U.S. Cl. 709/206; 715/728; 709/227; 710/15; 705/26.1

(57) ABSTRACT

Embodiments are disclosed herein that relate to enabling a vehicle user to obtain, via a voice-activated system, content that the user requests and that is not to be locally stored. For example, one disclosed embodiment comprises, in a vehicle, a voice-activated computing device including a processor, and memory comprising instructions stored thereon that are executable by the processor to receive from a user an input of a voice command requesting an item of content, determine whether the item of content is stored locally, and if the item of content is not stored locally, then send via a network the voice command to a remote service for analysis. The computing device is further configured to receive a response from the remote service comprising information regarding the item of content for presentation to the user, and present the information via an output to the user.

### BACKGROUND

Some vehicles are equipped with voice-activated control systems that allow a user of the vehicle to control various vehicle functions by voice command. For example, some passenger automobiles may comprise a voice-activated control system configured to interface with a portable device, such as a portable media player or smart phone, to enable a vehicle user to use voice commands to control the play of media items stored on the portable device via the vehicle's sound system. Likewise, such systems also may allow a user to call a contact stored on a cellular telephone by voice command.

### SUMMARY

Various embodiments are disclosed herein that relate to assist a vehicle user in obtaining, via a voice-activated system, content that the user requests and that is determined not to be locally stored. For example, one disclosed embodiment provides, in a vehicle, a voice-activated computing device configured to receive from a user an input of a voice command requesting an item of content, determine whether the item of content is stored locally, and if the item of content is not stored locally, then send via a network the voice command to a remote service. The computing device is further configured to receive a response from the remote service comprising information regarding the item of content for presentation to the user, and present an output to the user comprising the information regarding the item of content.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a block diagram of an embodiment of a vehicle comprising a computing device and a portable device in communication with the computing device.

FIG. 2 shows a flow diagram depicting an embodiment of a method of assisting a user of a voice-activated computing device in a vehicle in obtaining content.

### DETAILED DESCRIPTION

Embodiments are disclosed herein that relate to enabling a vehicle user to obtain, via a voice-activated computing device on the vehicle, content that the user requests and that is determined not to be locally stored, for example, in memory on the vehicle, or on a portable device connected to the vehicle. For example, if a user inputs a voice command requesting to play a song and the computing device determines that the song is not stored locally, the computing device may then contact a remote service to seek assistance with obtaining the item of content for the user. It will be understood that the item of content may be any suitable type of content, including but not limited to media content, contact names and/or telephone numbers, etc. It will further be understood that the computing device may be configured to assist the user in obtaining the item of content in any suitable manner, various non-limiting examples of which are described in more detail below.

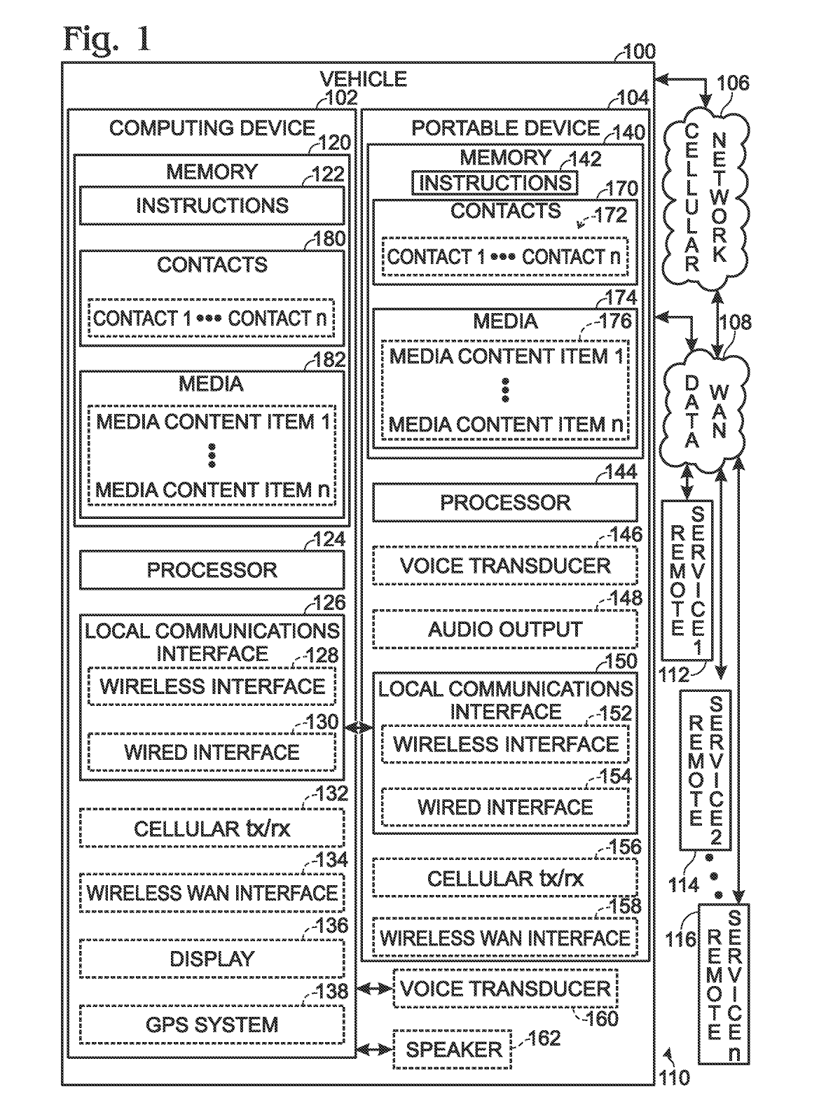

FIG. 1 shows a schematic block diagram of an embodiment of a vehicle 100 comprising a computing device 102. Further, a portable device 104 is shown being located in the vehicle and in communication with the computing device 102. The portable device 104 may be any suitable type of device, including but not limited to a portable media player, a mobile device, a smart phone or other cellular phone, a memory device such as a thumb drive, a laptop computer or notebook computer, other suitable hardware device, etc.

The computing device 102 and/or the portable device 104 may be configured to connect to a wireless network, such as a cellular network 106 and/or a wide area data network (WAN) 108 to allow the computing device 102 and/or the portable device 104 to communicate with remote devices via such networks. For example, the computing device 102 and/or portable device 104 may be configured to connect to WAN 108, either directly or through cellular network 106, to access one or remote services 110, shown in FIG. 1 as example remote service 1 112, remote service 2 114, and remote service n 116. The remote services 110 may be configured to provide information that is not stored locally on the vehicle 100 (e.g. in memory on the computing device 102 or portable device 104).

The computing device 102 comprises memory 120, such as computer-readable storage, containing instructions 122, such as one or more computer programs, stored thereon that are executable by a processor 124 to perform various vehicle-related functions. For example, the instructions 122 stored in memory 120 may be executable to receive from a user an input of a voice command requesting an item of content, determine whether the item of content is stored locally, and if the item of content is not stored locally, then send the voice command to one of remote services 110 for analysis. The remote service may then analyze the vocal input and provide a response to the computing device 102 comprising information related to assisting the user in obtaining the requested content. The computing device 102 may then present this information via an output, such as an audible and/or visual output, to the vehicle user.

The computing device 102 further comprises a local communications interface 126 to allow the computing device 102 to communicate with the portable device 104. The local communications interface 126 may be configured to communicate with the portable device in any suitable manner. For example, the local communications interface 126 may comprise a wireless communications interface 128 to enable communications via a short-range wireless protocol, such as Bluetooth, and/or may comprise a wired communications interface 130 configured to allow communication with the portable device 104 via a cable. It will be understood that these specific local communications interfaces are described for the purpose of example, and are not intended to be limiting in any manner.

In some embodiments, the computing device 102 may comprise other communications capabilities. For example, the computing device 102 may comprise a cellular transmitter/receiver 132, and/or a wireless network interface 134, such as a WIMAX transmitter/receiver or the like. Such communications capabilities may allow the computing device 102 to connect directly to cellular network 106 and/or WAN 108, without the use of portable device 104. In other embodiments, the computing device 102 may not comprise communications capabilities that allow it to connect directly to networks external to the vehicle, and instead may utilize communications capabilities on the portable device 104 to connect to the cellular network 106 and/or the WAN 108.

In some embodiments, the computing device 102 may be configured to provide output to a display 136 located within the vehicle 100, for example, on a dashboard of the vehicle 100. Using such a display, the computing device 102 may display various information, including but not limited to information related to vehicle status and performance, information related to media that is playable and/or being played via an entertainment system contained within the vehicle, information related to other content that is stored in memory on the computing device 102 and/or the portable device 104, etc. Further, the vehicle also may include a global positioning (GPS) system 138 configured to receive signals from GPS satellites, to determine a position of the vehicle based upon the received signals, and to display the location of the vehicle to a user via a map displayed on the display 136. It will be understood that other embodiments may not include a display 136 and/or a GPS system 138, and/or may include any other suitable items not illustrated herein.

The portable device 104 also includes memory 140 comprising instructions 142 stored thereon that are executable by a processor 144 on the portable device to perform various functions related to operating the portable device. Further, in embodiments where the portable device 104 is a smart phone, cell phone, or otherwise is configured enable cellular communications, the portable device 104 may comprise a voice transducer 146 to receive voice input, and an audio output 148, such as a speaker.

The portable device 104 further comprises a local communications interface 150 configured to communicate with the local communications interface 126 of the computing device 102. The local communications interface 150 may be configured to communicate with the local communications interface 126 of the computing device 102 in any manner. For example, the local communications interface 150 may comprise a wireless communications interface 152 to enable communications with the computing device 102 via a short-range wireless protocol, such as Bluetooth, and/or may comprise a wired communications interface 154 configured to allow communication with the portable device 104 via a cable. It will be understood that these specific local communications interfaces are described for the purpose of example, and are not intended to be limiting in any manner.

In addition to local communications interface 150, the portable device may comprise other communications capabilities. For example, the portable device 104 may comprise a cellular transmitter/receiver 156, and/or a wireless network interface 158, such as a WIMAX transmitter/receiver or the like. In other embodiments, the portable device 104 may not comprise communications capabilities that allow it to connect directly to networks external to the vehicle, and instead may utilize communications capabilities on the computing device 102 to connect to the cellular network 106 and/or the WAN 108.

As mentioned above, the computing device 102 is configured to receive voice commands from a user, and may further be configured to provide audible and/or visual outputs to the user. Therefore, in some embodiments, the vehicle 100 may comprise a voice transducer 160 to receive voice inputs, and a speaker 162 or the like to provide audible and/or visual outputs, while in other embodiments, the voice transducer 146 of the portable device may be used to receive voice inputs, and/or the audio output 148 on the portable device 104 may be used to output audible and/or visual outputs. It will be understood that these embodiments are described for the purpose of example, and that any other suitable configuration of voice transducer and speaker may be used.

The portable device 104 may comprise various items of content stored in memory 140. For example, the portable device 104 may include a list of contacts 170, shown in FIG. 1 as a list 172 of n contacts. Each contact in the list of contacts may comprise, for example, a contact name, one or more contact telephone numbers (home, office, cell, etc.), a contact email address, a contact street address, and/or any other suitable information. The portable device 104 also may include items of media content 174, shown as a list 176 of n media items. The media content 174 may comprise any suitable type of media content. Examples of types of media content include, but are not limited to, audio content (e.g. songs, albums, artists, etc.), audio/video content, video content, etc. In some embodiments, the computing device 102 also comprises content stored in memory 120, including but not limited to contacts 180 and media content 182. It will be understood that any other suitable types of content other than media content and contacts may be stored on the portable device 104 and utilized as described herein without departing from the scope of the present disclosure.

As described above, the computing device may be configured to receive voice inputs from a user requesting content, and in response, to provide the content to the user. With current in-vehicle systems, the ability of the computing device 102 to recognize the content portion of the request (e.g. artist name, album name, contact name, etc.) may be limited to the speech grammar which is locally present. This is because the speech grammar may be based upon the index of the content list and/or contacts list of the portable device 104 and/or of the computing device 102. Therefore, if the content portion of a request is not recognized, such in-vehicle systems may simply alert the user that the requested content is not recognized.

On the other hand, the embodiments disclosed herein assist a user in obtaining requested content that is not stored locally within the vehicle by sending a voice command containing unrecognized content grammar to one or more remote services 110, thereby allowing the remote service to analyze and recognize the speech utterance. Upon recognizing the speech utterance, the remote service can return a response to the computing device 102. The computing device 102 may then present the response to the user as an offer for assistance in obtaining the requested content item. For example, the computing device 102 may present a “buy now” offer to the user that allows the user to buy the requested content item from an online store, an “add to contacts” option that allows the user to add a requested contact to a contact list, etc. It will be understood that these examples of assistance that can be provided for a requested content item are presented for the purpose of example, and are not intended to be limiting in any manner.

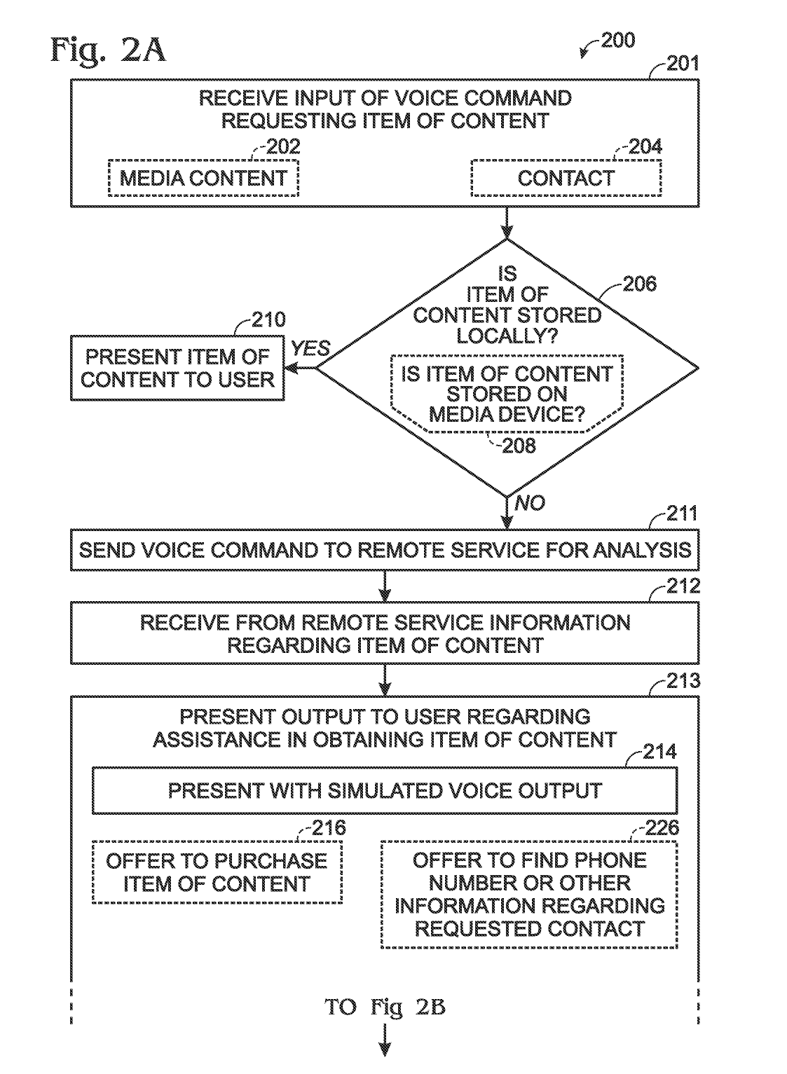

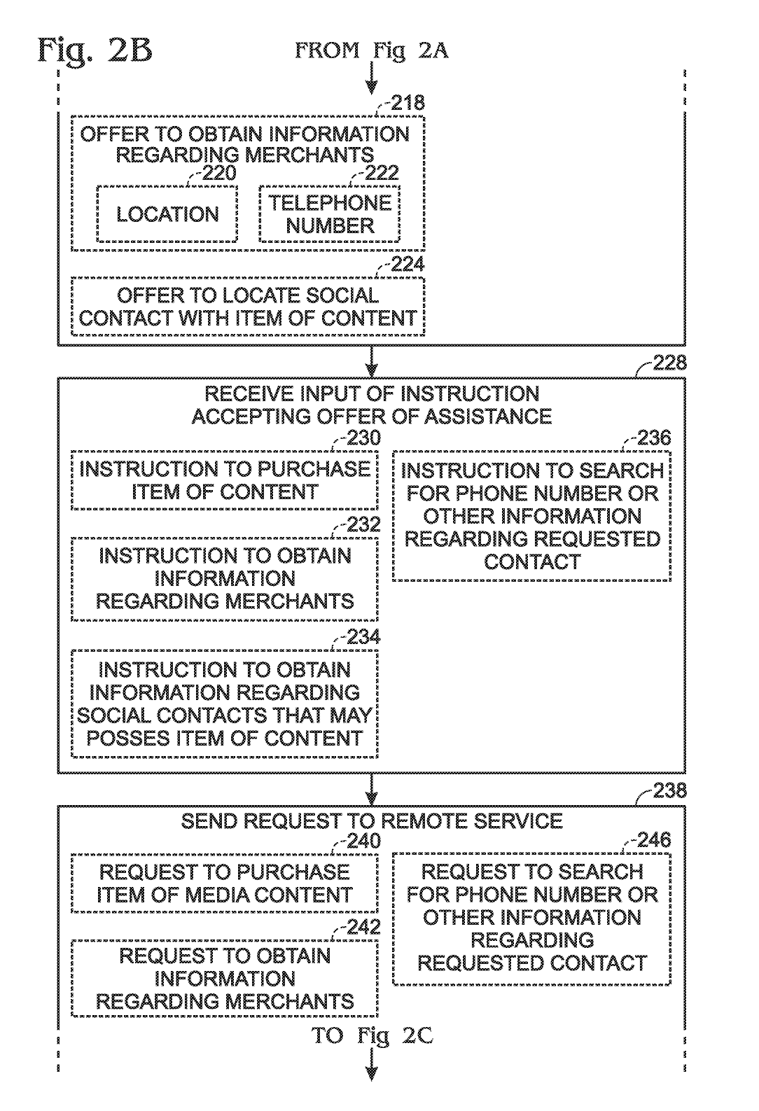

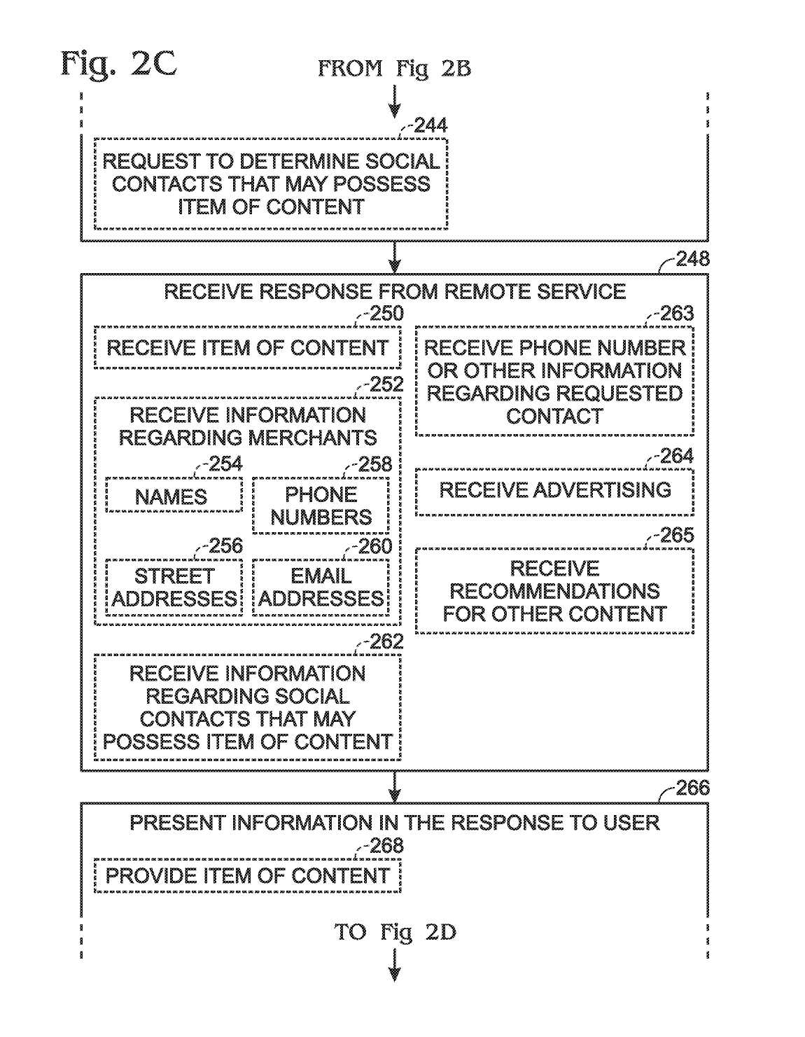

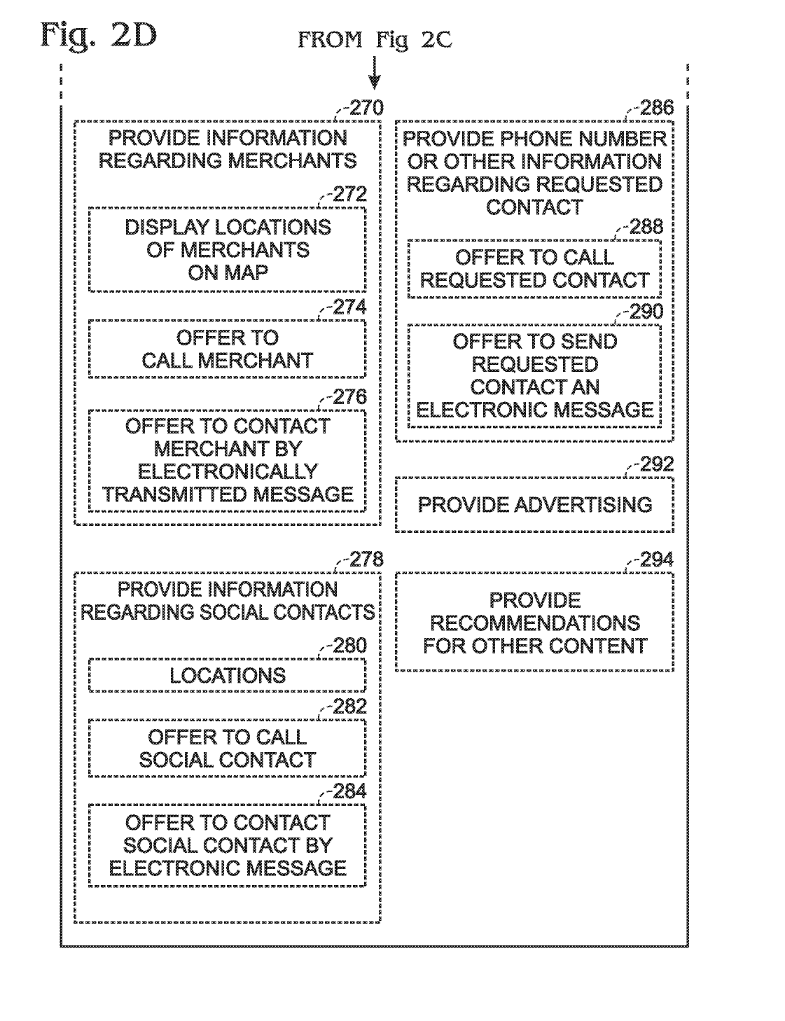

FIG. 2 shows an embodiment of a method 200 for assisting a vehicle user in obtaining content that may or may not be locally stored. Method 200 comprises, at 201, receiving a voice command requesting an item of content, such as an item of media content 202 or a contact 204. Examples of requests for items of media content may include, but are not limited to, requests such as “play artist (name)”, “play song (name)”, and the like. Examples of requests for contacts may include, but are not limited to, requests such as “call home (name)”, “call cell (name)”, “send text message (name)”, etc.

Next, method 200 comprises, at 206, determining whether the requested content is stored locally. For example, this may comprise determining whether the item of content is stored on a portable media device connected to voice-activated computing device, as indicated at 208. This also may comprise determining whether the item of content is stored in memory on the voice-activated computing device, or on any other suitable device that is connected to the voice-activated computing device. Examples of devices that may be connected to the voice-activated computing device include, but are not limited to, smart phones and other cell phones, laptop computers, netbooks, personal digital assistants (PDAs), memory devices, and/or any other suitable portable device capable of storing content and communicating with the voice-activated computing device via a wired or wireless connection.

If it is determined at 206 that the requested item of content is stored locally, then method 200 comprises, at 210, presenting the item of content to the user. For example, if the request was to play media content (e.g. “play song (name)”), then the requested media content item is played. As another example, if the request was related to call a cell phone number of a contact (e.g. “call cell (name)”), then the number is dialed.

On the other hand, if it is determined at 206 that the requested item of content is not stored locally (e.g. the voice command contains unrecognized content grammar, but the voice command is otherwise valid), then, at 211, the voice command is sent to a remote service for analysis. The voice command may be sent to the remote service in any suitable manner. For example, in some cases, the voice-activated computing device may send the voice command via wireless communications capabilities of the portable device, while in other cases, the voice-activated computing device may send the voice command via its own wireless network communications capabilities. The remote service may then analyze the voice command to search one or more databases for information related to the requested content. For example, in some embodiments, the remote service may convert the speech command to text and then use the text to perform one or more database searches. In other embodiments, the utterance itself may be used to perform database searching.

Method 200 next comprises, at 212 receiving from the remote service information regarding the item of content, such as an identity of a closest content item match to the received voice command. Then, method 200 comprises then presenting information regarding assistance in obtaining the requested content item to the user at 213. The information may be presented via an audible and/or visual output, as indicated at 214, or may be presented in any other suitable manner (e.g. via a display screen within the vehicle). For example, where the requested item of content comprises an item of media content, such as a song or album, the information presented to the user may comprise an offer to purchase the item of media content from an online store, as indicated at 216. Likewise, as indicated at 218, the information presented to the user may comprise an offer to obtain information related to local merchants that sell the item of media content, including but not limited to the merchant location 220 (e.g. street address), telephone number 222, and/or driving directions (e.g. determined via GPS system 138 and presented via display 136) to such merchant, if such merchant has opted to allow the provision of such information. The information presented to the user may also comprise an offer to locate a requested social contact that may possess the item of content, as indicated at 224, so that the user can obtain the item of content from the social contact, if the social contact has opted to allow this information to be provided.

Further, as indicated at 226, where the requested item of content comprises a request to commence communications with a contact, the information presented to the user may comprise an offer to find information regarding the requested contact, such as a telephone number, email address, street address, directions, etc., if the social contact has opted to allow this information to be provided to others.

The information received from the remote service may be presented to a user in any suitable manner. For example, where the remote service is able to identify the requested contact unambiguously, the information may be presented to the user in the form of a question or confirmation that the requested contact is to be added to the user's contact list stored on the portable device 104 and/or voice-activated computing device. Likewise, where the remote service is not able to identify the requested contact unambiguously, one or more questions regarding additional information requested by the remote service may be presented to the user to help unambiguously identify the requested contact.

Method 200 next comprises, at 228, receiving from the user an input of an instruction from the user, such as a voice command or other suitable input, accepting (or refusing) the offer for assistance. Depending upon the nature of the requested content, this acceptance may take various forms. For example, in the case of an item of media content, the instruction may be a confirmation to purchase or otherwise download the item of content, as indicated at 230. The instruction also may comprise an instruction to obtain information regarding a merchant that sells the item of content (telephone number, email address, street address, directions to the merchant from a current location, etc.) and that has opted to allow such information to be provided, as indicated at 232. Further, the instruction also may comprise an instruction to obtain information regarding social contacts that may possess the requested item of content and that have opted to allow such information to be provided, as indicated at 234.

Likewise, where the requested content relates to a contact and where the contact has opted to allow such information to be provided, the instruction received may comprise a confirmation to search for a phone number or other information (email address, street address, driving directions to the contact's street address, etc.) regarding the requested contact, as indicated at 236. The request may include more specific information as well. For example, a user may specify how to search for the contact (e.g. white pages, yellow pages, specified social networking website(s), etc.). It will be appreciated that, if the instruction received is an instruction that refuses the offer, method 200 may end.

Continuing, method 200 next comprises, at 238, sending a request to the remote service in response to the input received from the user at 228. This request may comprise any suitable information. For example, as indicated at 240, the request may comprise a request to purchase an item of media content. Further, as indicated at 242, the request may comprise a request to obtain information regarding merchants that sell the requested item of content and that have opted to allow the provision of such information, such as a merchant telephone number, a merchant street address, driving directions to a merchant, and/or any other suitable information. The request may also comprise a request to determine the identity, phone number, address, of any social contacts that may possess the item of contact, directions to a social contact's address, etc., and that have opted to allow the provision of such information, as indicated at 244. Additionally, where the requested content relates to a contact, the request may comprise a request to search for information related to the contact, if the contact has opted to allow the provision of such information, as indicated at 246. Examples of such information include, but are not limited to, a telephone number, an address, directions to an address, instructions specifying particular websites or databases to search, etc.

After sending the request to the remote service, the remote service may process the request and then send a response to the voice-activated computing device. Thus, method 200 next comprises, at 248, receiving a response from the remote service. The response may comprise any suitable information. For example, the response may comprise a copy of a requested item of media content, as indicated at 250. Additionally, as indicated at 252, the response may comprise information regarding one or more merchants that sell the item of content and that have opted to allow such information to be provided, such as names 254, street addresses 256 (as well as driving directions), phone numbers 258, email addresses 260, and/or any other suitable information regarding the one or more merchants. Further, as indicated at 262, the information may include information regarding social contacts that may possess the item of content and that have opted to allow such information to be provided. The information regarding social contacts may include information such as a name, telephone number, email address, street address, directions to a street address, etc. of a contact that may possess the item of content. Additionally, where the requested content relates to a contact, the response may comprise similar information related to the contact, as indicated at 263. Examples of such information include, but are not limited to, a telephone number, an address, directions to an address, etc. In yet other use scenarios, in addition to returning information regarding the requested content item, the remote service also may return advertising related to the request, as indicated at 264, recommendations of other content, as indicated at 265, and/or any other suitable information.

After receiving the response from the remote server at 248, method 200 next comprises, at 266, presenting the information in the response to the user. This may comprise, for example, providing the item of content to the user, as indicated at 268. As a more specific example, where the requested content is an item of media content, the media content may be saved on the media player and/or on the voice-activated computing device, and/or played for the user via an in-vehicle media system or a portable media player connected to the voice activated computing device. Presenting the information in the response to the user also may comprise, at 270, providing information regarding one or more merchants that sell the item of content. For example, as indicated at 272, the locations of one or more merchants that have allowed such information to be provided may be displayed on a map via display 136. Further, the information may comprise an offer to call a merchant, as indicated at 274, and/or an offer to contact the merchant by electronically transmitted message (e.g. instant message, text message, email, etc.), as indicated at 276. In some embodiments, where an offer to contact the merchant by electronic message is presented, a user may input the body of a message via voice input, and the user's words may be converted into text to form the message body. Further, in some embodiments, voice commands also may be used to control the sending of the message.

Additionally, as indicated at 278, the information in the response that is presented to the user may comprise information regarding social contacts that may possess the item of content and that have opted to allow such information to be provided. This information may include locations (e.g. street addresses) of one or more contacts 280, an offer to call a social contact 282, an offer to contact a social contact by electronic message 284, and/or any other suitable information.

Continuing, if the requested content item comprises information related to a contact and the contact has opted to allow such information to be provided, then providing the item of content may comprise saving and/or presenting a contact name, telephone number, email address, street address, directions to a street address (e.g. displayed on display 136), etc., as indicated at 286. Further, the information presented to the user may comprise an offer to call the requested contact, as indicated at 288, and/or an offer to send the requested contact an electronic message (e.g. instant message, text message, email, etc.), as indicated at 290.

One specific example of an interaction between a voice-activated computing device and a user according to method 200 is as follows. First, a user requests via a voice command the voice-activated computing device to play music by artist X. The voice-activated computing device compares the received content speech grammar to locally stored content speech grammar. If the voice-activated computing device finds no match, the computing device then may contact a remote service with the unknown speech grammar. Upon receiving a response from the remote service with information regarding content that the remote service found to match the user's request, the voice-activated computing device then outputs a request to the user, such as any of the following.

“You don't have artist X on the device. Would you like me to direct you to an online music store?”

“You don't have artist X on your device. Would you like me to show you directions to the nearest Best Buy? Would you also like to know how many copies Best Buy has for artist X albums?”

“You don't have artist X on your device. Would you like to add a reminder to your calendar to buy an artist X CD?”

In yet other use scenarios, in addition to returning information regarding the requested content item, the remote service also may provide advertising to the user, as indicated at 292, recommendations of other content for purchasing, as indicated at 294, and/or any other suitable information. It will be understood that similar scenarios may be followed when a user requests the voice-activated computing device to call, message, etc. a contact.

It will be understood that these specific transactions are presented for the purpose of example, and are not intended to be limiting in any manner. It will further be understood that the specific examples of assistance that may be offered in obtaining requested content that is not locally stored is presented for the purpose of example, and should not considered to be limiting in any manner, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description.

The subject matter of the present disclosure includes all novel and nonobvious combinations and subcombinations of the various processes, systems and configurations, and other features, functions, acts, and/or properties disclosed herein, as well as any and all equivalents thereof.

1. In a vehicle, a voice-activated computing device comprising:
a processor; and
memory comprising instructions stored thereon that are executable by the processor to:
receive from a user an input of a voice command requesting an item of content;
determine whether the item of content is stored locally;
if the item of content is not stored locally, then send via a network the voice command to a remote service for analysis;
receive a response from the remote service comprising information regarding the item of content for presentation to the user; and
present to the user an output comprising the information regarding the item of content.

2. The computing device of claim 1, further comprising a communications interface configured to connect to and enable communication with a portable device located within the vehicle.

3. The computing device of claim 2, further comprising a portable device connected to the computing device, and wherein the instructions are executable to determine whether the content is stored locally by determining whether the content is stored on the portable device.

4. The computing device of claim 1, wherein the output presented to the user comprises an audible and/or visual output.

5. The computing device of claim 1, wherein the item of content comprises an item of media content.

6. The computing device of claim 5, wherein the output comprising the information regarding the item of content includes an offer for the user to purchase the item of media content.

7. The computing device of claim 6, wherein the instructions are further executable to:
receive an instruction from the user to purchase the item of media content;
send a request to purchase the item of media content;
receive the item of media content; and
provide the item of media content to the user.

8. The computing device of claim 5, wherein:
the output comprising the information regarding assistance in obtaining the item of content includes an offer to contact a merchant that sells the item of media content; and
wherein the instructions are further executable to:
receive an instruction from the user to contact the merchant that sells the item of media content; and
contact the merchant that sells the item of media content by sending one or more of a telephone call and an electronically transmitted message.

9. The computing device of claim 5, wherein the computing device further comprises a display, wherein the output comprising the information regarding the item of content further comprises an offer to locate on a map displayed on the display a merchant that sells the item of media content; and
wherein the instructions are further executable to:
receive an instruction from the user to locate on the map displayed on the display the merchant that sells the item of media content; and
display on the display a location of the merchant that sells the item of media content.

10. The computing device of claim 5, wherein the output comprising the information regarding the item of content includes information regarding one or more social contacts of the user that own the item of media content; and
wherein the instructions are further executable to:
receive from the user a request to contact a requested social contact; and
contact the requested social contact by one or more of cellular phone and electronic message.

11. The computing device of claim 1, wherein the computing device comprises a communications interface, wherein the item of content requested comprises a contact, and wherein the voice command requesting the item of content comprises a voice command to call the contact via a cellular phone connected to the computing device via the communications interface.

12. The computing device of claim 11, wherein:
the output comprising the information regarding the item of content includes an offer to search a listing service for information related to the contact;
and wherein the instructions are further executable to receive an input from the user requesting information related to the contact;
send a request for information related to the contact;
receive the information related to the contact; and
present the information related to the contact to the user.

13. A vehicle, comprising:
a voice-activated computing device comprising
a portable device communications interface configured to connect to and enable communications with a portable device,
a processor, and
memory comprising instructions stored thereon that are executable by the processor to:
receive from a user an input of a voice command requesting an item of content;
determine whether the item of content is stored on a portable device connected to the communications interface;
if the item of content is not stored on the portable device, then send the voice command to a remote service;
receive from the remote service information regarding assistance in obtaining the item of content;
present to the user a audible and/or visual output of the information regarding assistance in obtaining the item of content;
receive from the user an instruction to obtain the item of content;
send a request to obtain the item of content;
receive the item of content; and
provide the item of content to the user.

14. The computing device of claim 13, wherein the instructions are executable to send the voice command to the remote service via wireless network communications capabilities of the portable device.

15. The computing device of claim 13, wherein the content item comprises one or more of a contact and an item of media content.

16. The computing device of claim 13, wherein the instructions are further executable to receive one or more of a recommendation and advertising from the server, and to present the one or more of the recommendation and advertising to the user.

17. In a vehicle comprising a voice-activated computing device configured to be connected to a portable media player, a method of providing content to a user of the computing device, the method comprising:
receiving from a user an input of a voice command requesting an item of media content;
determining whether the item of media content is stored on a portable media player connected to the computing device;
if the item of media content is not stored on the portable media player, then sending the voice command to a remote service;
receiving from the remote service information regarding the item of media content;
presenting to the user an audible and/or visual output comprising an offer to purchase the item of media content;
receiving from the user an instruction to purchase the item of media content;
sending a request to purchase the item of media content to the remote service;
receiving the item of media content from the remote service; and
providing the item of media content to the user.

18. The method of claim 17, further comprising storing the item of media content on the portable media player after receiving the item of media content from the remote service.

19. The method of claim 17, further comprising connecting to the remote service via wireless network communications capabilities of the portable media player.

20. The method of claim 17, further comprising receiving one or more of a recommendation and advertising from the server, and to present the one or more of the recommendation and advertising to the user.
